(19) United States
(12) Patent Application Publication
(10) Pub. No.: US 2025/0368043 A1
(43) Pub. Date: Dec. 4, 2025

(54) SYSTEMS AND METHODS FOR IMPROVING DEVICE RECONNECTION AT REMOTE START

(71) Applicant: Toyota Motor North America, Inc., Plano, TX (US)

(72) Inventors: Wilson-Boon Siang KHOO, Allen, TX (US); Ming M. MENG, Novi, MI (US); Sindy WU, Plano, TX (US)

(73) Assignees: Toyota Motor North America, Inc., Plano, TX (US); Toyota Jidosha Kabushiki Kaisha, Toyota-shi, Aichi-ken (JP)

(21) Appl. No.: 18/680,692

(22) Filed: May 31, 2024

(51) Int. Cl. B60K 35/28; B60K 35/22; H04W 4/48; H04W 4/80; H04W 76/10

(52) U.S. Cl. CPC B60K 35/28; B60K 35/22; H04W 4/48; H04W 76/10; B60K 2360/164; B60K 2360/589; H04W 4/80

(57) ABSTRACT

A method, computer program product, and computer system for detecting, by an infotainment system of a vehicle, that a client electronic device has a connection to the infotainment system via a first type of wireless network. A signal strength value of the first type of wireless network connected between the client electronic device and the infotainment system may be detected. It may be determined that the signal strength value of the first type of wireless network connected between the client electronic device and the infotainment system exceeds a threshold value. A connection may be established between the client electronic device and the infotainment system via a second type of wireless network based upon, at least in part, the signal strength value the first type of wireless network connected between the client electronic device and the infotainment system exceeding the threshold value.

### BACKGROUND

Use of remote starting functions (e.g., via smartphone application or key FOB) is very useful, especially during overly cold or overly hot days, as the car can warm up/cool down the interior as desired without having to be in the vehicle. While there may be conveniences, there may also be problems specifically directed to technology.

### SUMMARY

In one example implementation, a method, performed by one or more computing devices, may include but is not limited to detecting, by an infotainment system of a vehicle, that a client electronic device has a connection to the infotainment system via a first type of wireless network. A signal strength value of the first type of wireless network connected between the client electronic device and the infotainment system may be detected. It may be determined that the signal strength value of the first type of wireless network connected between the client electronic device and the infotainment system exceeds a threshold value. A connection may be established between the client electronic device and the infotainment system via a second type of wireless network based upon, at least in part, the signal strength value the first type of wireless network connected between the client electronic device and the infotainment system exceeding the threshold value.

One or more of the following example features may be included. Detecting that the client electronic device is connected to the infotainment system via the first type of wireless network may occur after a remote starting of the vehicle. The second type of wireless network may have a weaker signal strength than the first type of wireless network. The second type of wireless network may operate on a different frequency band than the first type of wireless network. The signal strength value of the first type of wireless network may be a Received Signal Strength Indicator (RSSI). A message may be displayed indicating whether the client electronic device successfully connected to the infotainment system. Establishment of a second connection between a second client electronic device and the infotainment system via the first type of wireless network may be attempted while the infotainment system is establishing the connection with the client electronic device via the second type of wireless network.

In another example implementation, a computing system may include one or more processors and one or more memories configured to perform operations that may include but are not limited to detecting, by an infotainment system of a vehicle, that a client electronic device has a connection to the infotainment system via a first type of wireless network. A signal strength value of the first type of wireless network connected between the client electronic device and the infotainment system may be detected. It may be determined that the signal strength value of the first type of wireless network connected between the client electronic device and the infotainment system exceeds a threshold value. A connection may be established between the client electronic device and the infotainment system via a second type of wireless network based upon, at least in part, the signal strength value the first type of wireless network connected between the client electronic device and the infotainment system exceeding the threshold value.

One or more of the following example features may be included. Detecting that the client electronic device is connected to the infotainment system via the first type of wireless network may occur after a remote starting of the vehicle. The second type of wireless network may have a weaker signal strength than the first type of wireless network. The second type of wireless network may operate on a different frequency band than the first type of wireless network. The signal strength value of the first type of wireless network may be a Received Signal Strength Indicator (RSSI). A message may be displayed indicating whether the client electronic device successfully connected to the infotainment system. Establishment of a second connection between a second client electronic device and the infotainment system via the first type of wireless network may be attempted while the infotainment system is establishing the connection with the client electronic device via the second type of wireless network.

In another example implementation, a computer program product may reside on a computer readable storage medium having a plurality of instructions stored thereon which, when executed across one or more processors, may cause at least a portion of the one or more processors to perform operations that may include but are not limited to detecting, by an infotainment system of a vehicle, that a client electronic device has a connection to the infotainment system via a first type of wireless network. A signal strength value of the first type of wireless network connected between the client electronic device and the infotainment system may be detected. It may be determined that the signal strength value of the first type of wireless network connected between the client electronic device and the infotainment system exceeds a threshold value. A connection may be established between the client electronic device and the infotainment system via a second type of wireless network based upon, at least in part, the signal strength value the first type of wireless network connected between the client electronic device and the infotainment system exceeding the threshold value.

One or more of the following example features may be included. Detecting that the client electronic device is connected to the infotainment system via the first type of wireless network may occur after a remote starting of the vehicle. The second type of wireless network may have a weaker signal strength than the first type of wireless network. The second type of wireless network may operate on a different frequency band than the first type of wireless network. The signal strength value of the first type of wireless network may be a Received Signal Strength Indicator (RSSI). A message may be displayed indicating whether the client electronic device successfully connected to the infotainment system. Establishment of a second connection between a second client electronic device and the infotainment system via the first type of wireless network may be attempted while the infotainment system is establishing the connection with the client electronic device via the second type of wireless network.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF DRAWINGS

FIG. 1 is an example diagrammatic view of a connection process coupled to an example distributed computing network according to one or more example implementations of the disclosure;

FIG. 2 is an example diagrammatic view of a client electronic device of FIG. 1 according to one or more example implementations of the disclosure;

FIG. 3 is an example flowchart of a connection process according to one or more example implementations of the disclosure; and

FIG. 4 is an example flowchart of a connection process according to one or more example implementations of the disclosure.

Like reference symbols in the various drawings may indicate like elements.

### DESCRIPTION

### System Overview

Use of remote starting functions (e.g., via smartphone application or key FOB) is very useful, especially during overly cold or overly hot days, as the car can warm up/cool down the interior as desired without having to be in the vehicle. While there may be conveniences, there may also be problems specifically directed to technology. For example, there may be situations where the user's smartphone is not within range of the vehicle at the time of remote start for the head unit (HU) or similar infotainment computing device to connect, so the user may see error message, such as, e.g., “Wireless Connection Failed” displayed every time. Once the user comes into the vehicle, the user can tap on a “retry” icon to establish the connection, but the user's expectation is to have car and HU automatically connected without manually interfering with the process.

Therefore, as will be discussed in greater detail below, the present disclosure may improve a reconnection strategy so that user can connect their smartphone's (or other computing device's) applications to the HU without seeing a connection error screen, even if the user's smartphone is not within range of the vehicle at the time of remote start for the head unit to connect. The present disclosure will use a weaker signal and a stronger signal (comparatively) to determine the range that will be used to gauge the range of device and apply reconnection logic to ensure a connection without error messages and/or without needing to manually interfere with the connection process.

In some implementations, the present disclosure may be embodied as a method, system, or computer program product. Accordingly, in some implementations, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, in some implementations, the present disclosure may take the form of a computer program product on a computer-usable storage medium having computer-usable program code embodied in the medium.

Software may include artificial intelligence (AI) systems, which may include machine learning or other computational intelligence. For example, AI may include one or more models used for one or more problem domains. When presented with many data features, identification of a subset of features that are relevant to a problem domain may improve prediction accuracy, reduce storage space, and increase processing speed. This identification may be referred to as feature engineering. Feature engineering may be performed by users or may only be guided by users. In various implementations, a machine learning system may computationally identify relevant features, such as by performing singular value decomposition on the contributions of different features to outputs.

In some implementations, the various computing devices may include, integrate with, link to, exchange data with, be governed by, take inputs from, and/or provide outputs to one or more AI systems, which may include models, rule-based systems, expert systems, neural networks, deep learning systems, supervised learning systems, robotic process automation systems, natural language processing systems, intelligent agent systems, self-optimizing and self-organizing systems, and others. Except where context specifically indicates otherwise, references to AI, or to one or more examples of AI, should be understood to encompass one or more of these various alternative methods and systems; for example, without limitation, an AI system described for enabling any of a wide variety of functions, capabilities and solutions described herein (such as optimization, autonomous operation, prediction, control, orchestration, or the like) should be understood to be capable of implementation by operation on a model or rule set; by training on a training data set of human tag, labels, or the like; by training on a training data set of human interactions (e.g., human interactions with software interfaces or hardware systems); by training on a training data set of outcomes; by training on an AI-generated training data set (e.g., where a full training data set is generated by AI from a seed training data set); by supervised learning; by semi-supervised learning; by deep learning; or the like. For any given function or capability that is described herein, neural networks of various types may be used, including any of the types described herein, and in embodiments a hybrid set of neural networks may be selected such that within the set a neural network type that is more favorable for performing each element of a multi-function or multi-capability system or method is implemented. As one example among many, a deep learning, or black box, system may use a gated recurrent neural network for a function like language translation for an intelligent agent, where the underlying mechanisms of AI operation need not be understood as long as outcomes are favorably perceived by users, while a more transparent model or system and a simpler neural network may be used for a system for automated governance, where a greater understanding of how inputs are translated to outputs may be needed to comply with regulations or policies.

Examples of the models (e.g., AI-based models) include recurrent neural networks (RNNs) such as long short-term memory (LSTM), deep learning models such as transformers, decision trees, support-vector machines, genetic algorithms, Bayesian networks, and regression analysis. Examples of systems based on a transformer model include bidirectional encoder representations from transformers (BERT) and generative pre-trained transformers (GPT). Training a machine-learning model (or other type of AI-based learning models) may include supervised learning (for example, based on labelled input data), unsupervised learning, and reinforcement learning. In various embodiments, a machine-learning model may be pre-trained by their operator or by a third party. Problem domains include nearly any situation where structured data can be collected, and includes natural language processing (NLP), including natural language understanding (NLU), computer vision (CV), classification, image recognition, etc. Some or all of the software may run in a virtual environment rather than directly on hardware. The virtual environment may include a hypervisor, emulator, sandbox, container engine, etc. The software may be built as a virtual machine, a container, etc. Virtualized resources may be controlled using, for example, a DOCKER container platform, a pivotal cloud foundry (PCF) platform, etc. Some or all of the software may be logically partitioned into microservices. Each microservice offers a reduced subset of functionality. In various embodiments, each microservice may be scaled independently depending on load, either by devoting more resources to the microservice or by instantiating more instances of the microservice. In various embodiments, functionality offered by one or more microservices may be combined with each other and/or with other software not adhering to a microservices model.

In some implementations, as noted above, AI-based learning models may include at least one of a transformer model, a convolutional neural network, a deep learning model trained on a set of outcomes of the value chain network entity, a supervised model, a semi-supervised model, an unsupervised model, or a reinforcement model, and the training data set for the AI-based learning models may include one or a set of objects or events that are labeled to classify the set of objects or events according to a classification taxonomy. Other examples of AI-based learning models (e.g., machine learning models) may include neural networks in general (e.g., deep neural networks, convolution neural networks, and many others), regression based models, decision trees, hidden forests, Hidden Markov models, Bayesian models, and the like. In some implementations, the present disclosure may include combinations where an expert system uses one neural network for classifying an item and a different (or the same) neural network for predicting a state of the item.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium or storage device may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, solid state drives (SSDs), a digital versatile disk (DVD), a Blu-ray disc, and an Ultra HD Blu-ray disc, a static random access memory (SRAM), dynamic RAM (DRAM), synchronous DRAM (SDRAM), synchronous graphics RAM (SGRAM), and video RAM (VRAM), analog magnetic tape, digital magnetic tape, rotating hard disk drive (HDDs), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

Examples of storage implemented by the storage hardware include a distributed ledger, such as a permissioned or permissionless blockchain. Entities recording transactions, such as in a blockchain, may reach consensus using an algorithm such as proof-of-stake, proof-of-work, and proof-of-storage. Elements of the present disclosure may be represented by or encoded as non-fungible tokens (NFTs). Ownership rights related to the non-fungible tokens may be recorded in or referenced by a distributed ledger. Transactions initiated by or relevant to the present disclosure may use one or both of fiat currency and cryptocurrencies, examples of which include bitcoin and ether.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java®, Smalltalk, C++ or the like. Java® and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as JavaScript, PERL, or Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a network, such as a cellular network, local area network (LAN), a wide area network (WAN), a body area network BAN), a personal area network (PAN), a metropolitan area network (MAN), etc., or the connection may be made to an external computer (for example, through the internet using an Internet Service Provider). The networks may include one or more of point-to-point and mesh technologies. Data transmitted or received by the networking components may traverse the same or different networks. Networks may be connected to each other over a WAN or point-to-point leased lines using technologies such as Multiprotocol Label Switching (MPLS) and virtual private networks (VPNs), etc. In some implementations, electronic circuitry including, for example, programmable logic circuitry, an application specific integrated circuit (ASIC), gate arrays such as field-programmable gate arrays (FPGAs) or other hardware accelerators, micro-controller units (MCUs), or programmable logic arrays (PLAs), integrated circuits (ICs), digital circuit elements, analog circuit elements, combinational logic circuits, digital signal processors (DSPs), complex programmable logic devices (CPLDs), etc. may execute the computer readable program instructions/code by utilizing state information of the computer readable program instructions to personalize the electronic circuitry, in order to perform aspects of the present disclosure. Multiple components of the hardware may be integrated, such as on a single die, in a single package, or on a single printed circuit board or logic board. For example, multiple components of the hardware may be implemented as a system-on-chip. A component, or a set of integrated components, may be referred to as a chip, chipset, chiplet, or chip stack. Examples of a system-on-chip include a radio frequency (RF) system-on-chip, an AI system-on-chip, a video processing system-on-chip, an organ-on-chip, a quantum algorithm system-on-chip, etc.

Examples of processing hardware may include, e.g., a central processing unit (CPU), a graphics processing unit (GPU), an approximate computing processor, a quantum computing processor, a parallel computing processor, a neural network processor, a signal processor, a digital processor, an analog processor, a data processor, an embedded processor, a microprocessor, and a co-processor. The co-processor may provide additional processing functions and/or optimizations, such as for speed or power consumption. Examples of a co-processor include a math co-processor, a graphics co-processor, a communication co-processor, a video co-processor, and an AI co-processor.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures (or combined or omitted). For example, two blocks shown in succession may, in fact, be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

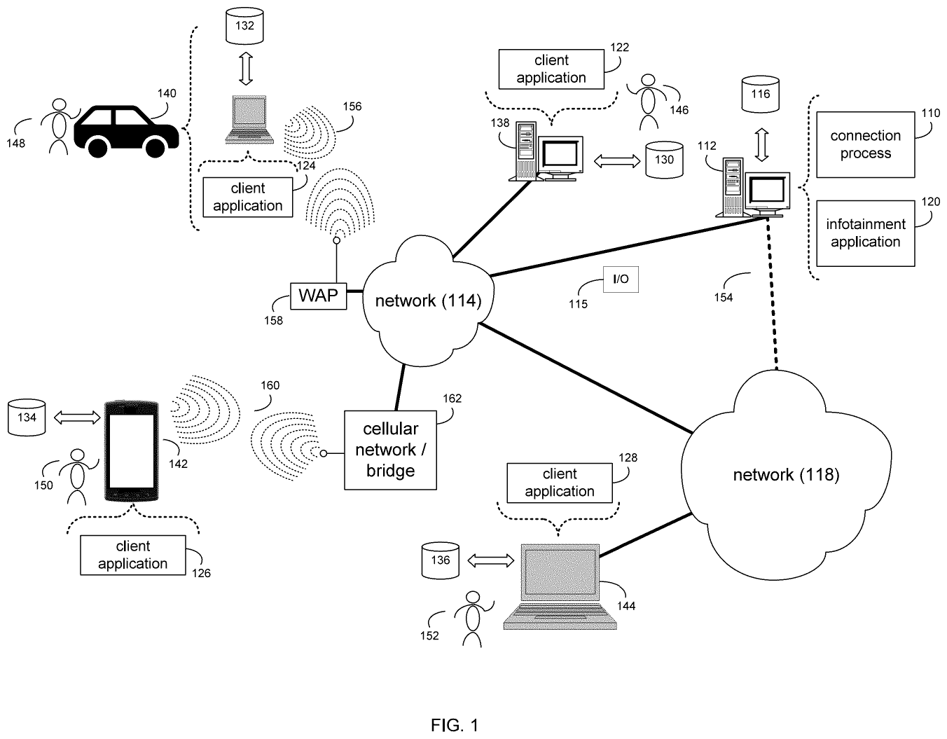

Referring now to the example implementation of FIG. 1, there is shown connection process 110 that may reside on and may be executed by a computer (e.g., computer 112), which may be connected to a network (e.g., network 114) (e.g., the internet or a local area network). Examples of computer 112 (and/or one or more of the client electronic devices noted below) may include, but are not limited to, a storage system (e.g., a Network Attached Storage (NAS) system, a Storage Area Network (SAN)), a personal computer(s), a laptop computer(s), mobile computing device(s), a server computer, a series of server computers, a mainframe computer(s), or a computing cloud(s). A SAN may include one or more of the client electronic devices, including a RAID device and a NAS system. In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 112 may execute an operating system, for example, but not limited to, Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a connection process, such as connection process 110 of FIG. 1, may detect, by an infotainment system of a vehicle, that a client electronic device has a connection to the infotainment system via a first type of wireless network. A signal strength value of the first type of wireless network connected between the client electronic device and the infotainment system may be detected. It may be determined that the signal strength value of the first type of wireless network connected between the client electronic device and the infotainment system exceeds a threshold value. A connection may be established between the client electronic device and the infotainment system via a second type of wireless network based upon, at least in part, the signal strength value the first type of wireless network connected between the client electronic device and the infotainment system exceeding the threshold value.

In some implementations, the instruction sets and subroutines of connection process 110, which may be stored on storage device, such as storage device 116, coupled to computer 112, may be executed by one or more processors and one or more memory architectures included within computer 112. In some implementations, storage device 116 may include but is not limited to: a hard disk drive; all forms of flash memory storage devices; a tape drive; an optical drive; a RAID array (or other array); a random access memory (RAM); a read-only memory (ROM); or combination thereof. In some implementations, storage device 116 may be organized as an extent, an extent pool, a RAID extent (e.g., an example 4D+1P R5, where the RAID extent may include, e.g., five storage device extents that may be allocated from, e.g., five different storage devices), a mapped RAID (e.g., a collection of RAID extents), or combination thereof.

In some implementations, network 114 may be connected to one or more secondary networks (e.g., network 118), examples of which may include but are not limited to: a local area network; a wide area network or other telecommunications network facility; or an intranet, for example. The phrase “telecommunications network facility,” as used herein, may refer to a facility configured to transmit, and/or receive transmissions to/from one or more mobile client electronic devices (e.g., cellphones, etc.) as well as many others.

In some implementations, computer 112 may include a data store, such as a database (e.g., relational database, object-oriented database, triplestore database, etc.), a data store, a data lake, a column store, and/or a data warehouse, and may be located within any suitable memory location, such as storage device 116 coupled to computer 112. In some implementations, data, metadata, information, etc. described throughout the present disclosure may be stored in the data store. In some implementations, computer 112 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, connection process 110 may be a component of the data store, a standalone application that interfaces with the above noted data store and/or an applet/application that is accessed via client applications 122, 124, 126, 128. In some implementations, the above noted data store may be, in whole or in part, distributed in a cloud computing topology. In this way, computer 112 and storage device 116 may refer to multiple devices, which may also be distributed throughout the network.

In some implementations, computer 112 may execute an infotainment application (e.g., infotainment application 120), examples of which may include, but are not limited to, e.g., a navigation application, a multimedia application, a connectivity application, a voice control application, a smartphone integration application, a touchscreen interface application, an internet and “apps” application, a rear-seat entertainment application, or other application that allows for combining information and/or entertainment with optional screens and/or audio for such things as navigation, multimedia, connectivity, voice control, smartphone integration, touchscreen interface, internet and apps, rear-seat entertainment, etc. In some implementations, connection process 110 and/or infotainment application 120 may be accessed via one or more of client applications 122, 124, 126, 128. In some implementations, connection process 110 may be a standalone application, or may be an applet/application/script/extension that may interact with and/or be executed within infotainment application 120, a component of infotainment application 120, and/or one or more of client applications 122, 124, 126, 128. In some implementations, infotainment application 120 may be a standalone application, or may be an applet/application/script/extension that may interact with and/or be executed within connection process 110, a component of connection process 110, and/or one or more of client applications 122, 124, 126, 128. In some implementations, one or more of client applications 122, 124, 126, 128 may be a standalone application, or may be an applet/application/script/extension that may interact with and/or be executed within and/or be a component of connection process 110 and/or infotainment application 120. Examples of client applications 122, 124, 126, 128 may include, but are not limited to, e.g., a VR application, XR or MR application, an AR application, a navigation application, a multimedia application, a connectivity application, a voice control application, a smartphone integration application, a touchscreen interface application, an internet and “apps” application, a rear-seat entertainment application, or other application that allows for combining information and/or entertainment with optional screens and/or audio for such things as navigation, multimedia, connectivity, voice control, smartphone integration, touchscreen interface, internet and apps, rear-seat entertainment, etc, a standard and/or mobile web browser, an email application (e.g., an email client application), a textual and/or a graphical user interface, a customized web browser, a plugin, an Application Programming Interface (API), or a custom application. The instruction sets and subroutines of client applications 122, 124, 126, 128, which may be stored on storage devices 130, 132, 134, 136, coupled to client electronic devices 138, 140, 142, 144, may be executed by one or more processors and one or more memory architectures incorporated into client electronic devices 138, 140, 142, 144.

In some implementations, one or more of storage devices 130, 132, 134, 136, may include but are not limited to: hard disk drives; flash drives, tape drives; optical drives; RAID arrays; random access memories (RAM); and read-only memories (ROM). Examples of client electronic devices 138, 140, 142, 144 (and/or computer 112) may include, but are not limited to, a personal computer (e.g., client electronic device 138), a vehicle's infotainment system computer (e.g., client electronic device 140), a smart/data-enabled, cellular phone (e.g., client electronic device 142), a notebook computer (e.g., client electronic device 144), a tablet, a server, a television, a smart television, a smart speaker, an Internet of Things (IoT) device, a media (e.g., audio/video, photo, etc.) capturing and/or output device, an audio input and/or recording device (e.g., a handheld microphone, a lapel microphone, an embedded microphone/speaker (such as those embedded within eyeglasses, smart phones, tablet computers, smart televisions, smart speakers, watches, etc.), an infotainment device (e.g., such as those found in vehicles combining information and/or entertainment with optional screens and/or audio for such things as navigation, multimedia, connectivity, voice control, smartphone integration, touchscreen interface, internet and apps, rear-seat entertainment, etc.), a dedicated network device, and combinations thereof. Client electronic devices 138, 140, 142, 144 may each execute an operating system, examples of which may include but are not limited to, Android™, Apple® iOS®, Mac® OS X®; Red Hat® Linux®, Windows® Mobile, Chrome OS, Blackberry OS, Fire OS, or a custom operating system.

In some implementations, one or more of client applications 122, 124, 126, 128 may be configured to effectuate some or all of the functionality of connection process 110 (and vice versa). Accordingly, in some implementations, connection process 110 may be a purely server-side application, a purely client-side application, or a hybrid server-side/client-side application that is cooperatively executed by one or more of client applications 122, 124, 126, 128 and/or connection process 110.

In some implementations, one or more of client applications 122, 124, 126, 128 may be configured to effectuate some or all of the functionality of infotainment application 120 (and vice versa). Accordingly, in some implementations, infotainment application 120 may be a purely server-side application, a purely client-side application, or a hybrid server-side/client-side application that is cooperatively executed by one or more of client applications 122, 124, 126, 128 and/or infotainment application 120. As one or more of client applications 122, 124, 126, 128, connection process 110, and infotainment application 120, taken singly or in any combination, may effectuate some or all of the same functionality, any description of effectuating such functionality via one or more of client applications 122, 124, 126, 128, connection process 110, infotainment application 120, or combination thereof, and any described interaction(s) between one or more of client applications 122, 124, 126, 128, connection process 110, infotainment application 120, or combination thereof to effectuate such functionality, should be taken as an example only and not to limit the scope of the disclosure.

In some implementations, one or more of users 146, 148, 150, 152 may access computer 112 and connection process 110 (e.g., using one or more of client electronic devices 138, 140, 142, 144) directly through network 114 or through network 118. Further, computer 112 may be connected to network 114 through network 118, as illustrated with phantom link line 154. Connection process 110 may include one or more user interfaces, such as browsers and textual or graphical user interfaces, through which users 146, 148, 150, 152 may access connection process 110.

In some implementations, the various client electronic devices may be directly or indirectly coupled to network 114 (or network 118). For example, client electronic device 138 is shown directly coupled to network 114 via a hardwired network connection. Further, client electronic device 144 is shown directly coupled to network 118 via a hardwired network connection. Client electronic device 140 is shown wirelessly coupled to network 114 via wireless communication channel 156 established between client electronic device 140 and wireless access point (i.e., WAP 158), which is shown directly coupled to network 114. WAP 158 may be, for example, an IEEE 802.11a, 802.11b, 802.11g, 802.11n, 802.11ac, Wi-Fi®, RFID, and/or Bluetooth™ (including Bluetooth™M Low Energy) or any device that is capable of establishing wireless communication channel 156 between client electronic device 140 and WAP 158 (e.g., Zigbee, Z-Wave, etc.). Client electronic device 142 is shown wirelessly coupled to network 114 via wireless communication channel 160 established between client electronic device 142 and cellular network/bridge 162, which is shown by example directly coupled to network 114.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used. In some implementations, computer 112 may be directed or controlled by an operator. Computer 112 may be hosted by one or more of assets owned by the operator, assets leased by the operator, and third-party assets. The assets may be referred to as a private, community, or hybrid cloud computing network or cloud computing environment. For example, computer 112 may be partially or fully hosted by a third party offering software as a service (SaaS), platform as a service (PaaS), and/or infrastructure as a service (IaaS). Computer 112 may be implemented using agile development and operations (DevOps) principles. In some implementations, some or all of computer 112 may be implemented in a multiple-environment architecture. For example, the multiple environments may include one or more production environments, one or more integration environments, one or more development environments, etc.

In some implementations, various I/O requests (e.g., I/O request 115) may be sent from, e.g., client applications 122, 124, 126, 128 to, e.g., computer 112 (and vice versa). Examples of I/O request 115 may include but are not limited to, data write requests (e.g., a request that content be written to computer 112) and data read requests (e.g., a request that content be read from computer 112). Client electronic devices 138, 140, 142, 144 and/or computer 112 may also communicate audibly using an audio codec, which may receive spoken information from a user and convert it to usable digital information. An audio codec may likewise generate audible sound for a user, such as through a speaker, e.g., in a handset of a client electronic device. Such sound may include sound from voice telephone calls, may include recorded sound (e.g., voice messages, music files, etc.) and may also include sound generated by applications operating on the client electronic devices.

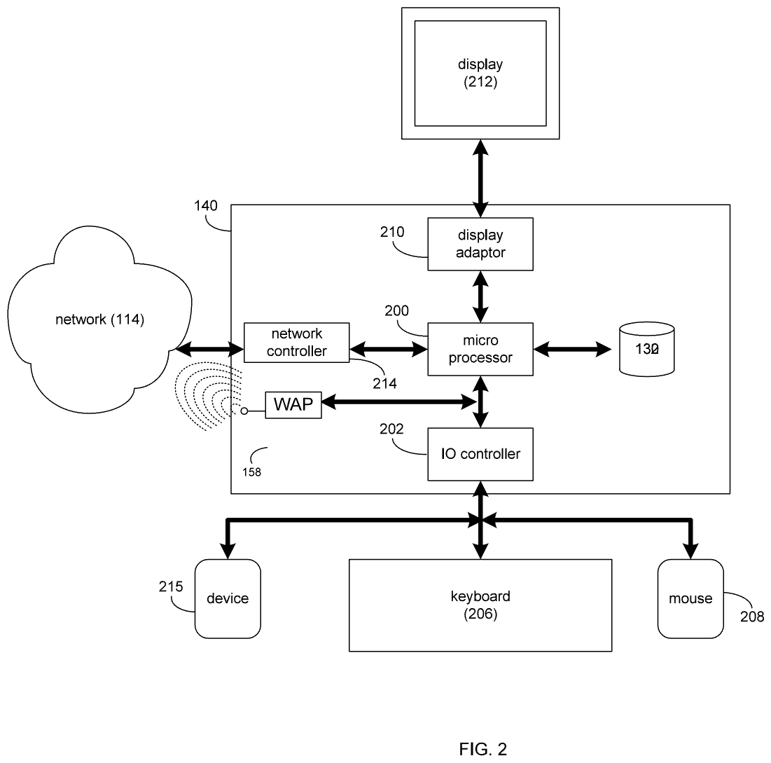

Referring also to the example implementation of FIG. 2, there is shown a diagrammatic view of client electronic device 140. While client electronic device 140 is shown in this figure, this is for example purposes only and is not intended to be a limitation of this disclosure, as other configurations are possible. Additionally, any computing device capable of executing, in whole or in part, connection process 110 may be substituted for client electronic device 140 (in whole or in part) within FIG. 2, examples of which may include but are not limited to computer 112 and/or one or more of client electronic devices 138, 142, 144.

In some implementations, client electronic device 140 may include a processor (e.g., microprocessor 200) configured to, e.g., process data and execute the above-noted code/instruction sets and subroutines. Microprocessor 200 may be coupled via a storage adaptor to the above-noted storage device(s) (e.g., storage device 132). An I/O controller (e.g., I/O controller 202) may be configured to couple microprocessor 200 with various devices (e.g., via wired or wireless connection), such as keyboard 206, pointing/selecting device (e.g., touchpad, touchscreen, mouse 208, etc.), scanner, custom device (e.g., device 215), USB ports, and printer ports. A display adaptor (e.g., display adaptor 210) may be configured to couple display 212 (e.g., touchscreen monitor(s), plasma, CRT, or LCD monitor(s), etc.) with microprocessor 200, while network controller/adaptor 214 (e.g., an Ethernet adaptor) may be configured to couple microprocessor 200 to network 114 (e.g., the Internet or a local area network).

Use of remote starting functions (e.g., via smartphone application or key FOB) is very useful, especially during overly cold or overly hot days, as the car can warm up/cool down the interior as desired without having to be in the vehicle. While there may be conveniences, there may also be problems specifically directed to technology. For example, there may be situations where the user's smartphone is not within range of the vehicle at the time of remote start for the head unit (HU) or similar infotainment computing device to connect, so the user may see error message, such as, e.g., “Wireless Connection Failed” displayed every time. Once the user comes into the vehicle, the user can tap on a “retry” icon to establish the connection, but the user's expectation is to have car and HU automatically connected without manually interfering with the process.

Therefore, as will be discussed in greater detail below, the present disclosure may improve a reconnection strategy so that user can connect their smartphone's (or other computing device's) applications to the HU without seeing a connection error screen, even if the user's smartphone is not within range of the vehicle at the time of remote start for the head unit to connect. The present disclosure will use a weaker signal and a stronger signal (comparatively) to determine the range that will be used to gauge the range of device and apply reconnection logic to ensure a connection without error messages and/or without needing to manually interfere with the connection process.

While the present disclosure may be described using Bluetooth and Wi-Fi as the networks, it will be appreciated after reading the present disclosure that other types of networks (e.g., cellular, ZigBee and Z-Wave, RFID, as well as any other networks mentioned herein, etc.) may also be used without departing from the scope of the present disclosure. As such, the use of Bluetooth and Wi-Fi should be taken as example only and not to otherwise limit the scope of the present disclosure.

### The Connection Process

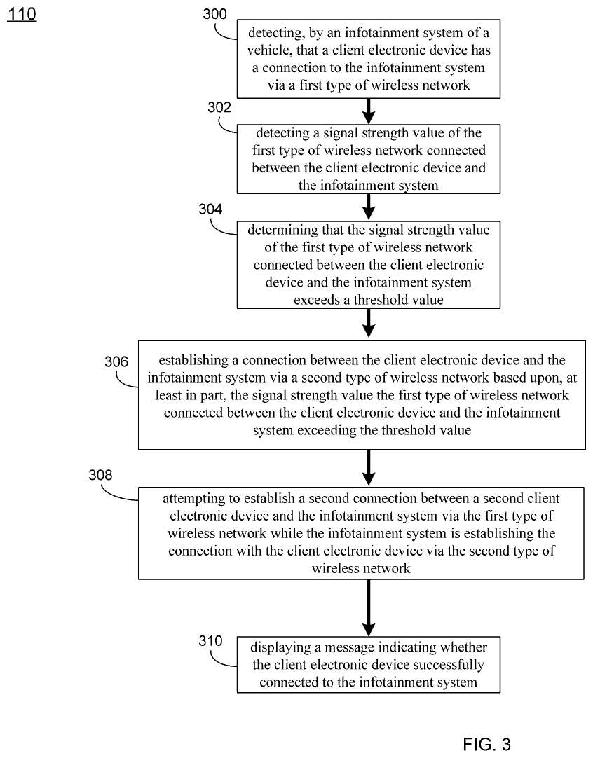

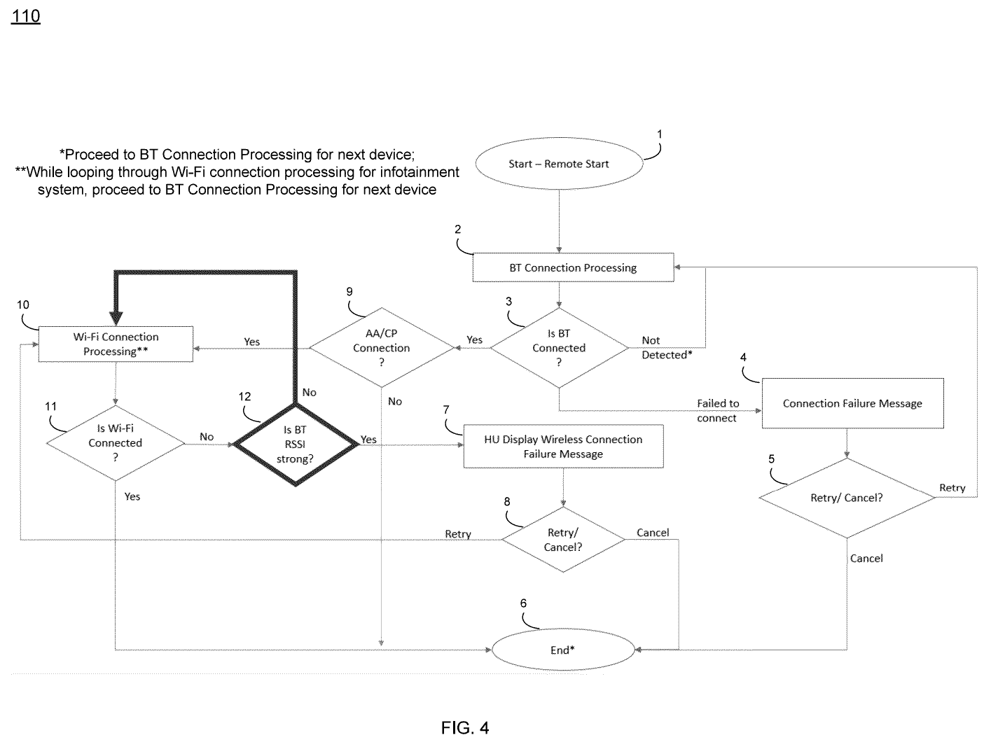

As discussed above and referring also at least to the example implementations of FIGS. 3-4, connection process 110 may detect 300, by an infotainment system of a vehicle, that a client electronic device has a connection to the infotainment system via a first type of wireless network. Connection process 110 may detect 302 a signal strength value of the first type of wireless network connected between the client electronic device and the infotainment system. Connection process 110 may determine 304 that the signal strength value of the first type of wireless network connected between the client electronic device and the infotainment system exceeds a threshold value. Connection process 110 may establish 306 a connection between the client electronic device and the infotainment system via a second type of wireless network based upon, at least in part, the signal strength value the first type of wireless network connected between the client electronic device and the infotainment system exceeding the threshold value.

In some implementations, connection process 110 may detect 300, by an infotainment system (e.g., client electronic device 140) of a vehicle, that a client electronic device has a connection to the infotainment system via a first type of wireless network, and in some implementations, detecting that the client electronic device is connected to the infotainment system via the first type of wireless network may occur after a remote starting of the vehicle. For instance, assume for example purposes only that a user (e.g., user 148) is using a client application (e.g., client application 124) on a client electronic device (e.g., client electronic device 142) to remotely start their vehicle. In the example, after user 148 has remotely started the vehicle connection process 110 may detect the client electronic devices 142 has a connection to the infotainment system. As a non-limiting example, assume that the first type of wireless network is any type of Bluetooth wireless network connection.

In some implementations, connection process 110 may detect 302 a signal strength value of the first type of wireless network connected between the client electronic device and the infotainment system. For instance, in some implementations, the signal strength value of the first type of wireless network may be a Received Signal Strength Indicator (RSSI). For example, RSSI may generally be described as a measurement used in wireless communication networks to estimate the power level that a receiving device (e.g., in this example the infotainment system) is getting from a signal (e.g., in this example the Bluetooth signal from client electronic devices 142). RSSI is usually expressed in decibels from, e.g., 0 to −120, although other ranges are possible. Generally, the closer the value is to 0, the stronger the signal. So, for instance, an RSSI of −70 dBm is stronger and therefore generally better for connectivity than an RSSI of −90 dBm. Thus, connection process 110 may use RSSI to determine the quality of a wireless transmission and whether client electronic devices 142 is within a good range of the network or if there are potential spots of signal weakness or interference to connect to the infotainment system.

It will be appreciated that other types of signal strengths may be used without departing from the scope of the present disclosure. For instance, SNR (Signal-to-Noise Ratio) may be used to measure the ratio of signal power to noise power in a communication channel as an indicator of the quality of a wireless transmission, as a higher SNR means a clearer signal with less interference. SNR is particularly useful in environments with high levels of background noise. As another example, RSRP (Reference Signal Received Power) may be used as a signal strength measurement in, e.g., LTE (Long Term Evolution) networks. RSRP measures the power of LTE reference signals spread over the entire bandwidth and may provide a more accurate indication of signal strength than RSSI in LTE networks. As another example, RSRQ (Reference Signal Received Quality) may be used alongside RSRP (e.g., as another LTE measurement). It indicates the quality of the received reference signal and is calculated from the RSRP and the RSSI measurements. As yet another example, SINR (Signal-to-Interference-plus-Noise Ratio) may be used similarly to SNR, but takes into account the level of interference from other signals, and while not limiting, may be particularly useful as a metric in wireless networks, including cellular and Wi-Fi, for understanding how external interference and noise affect the signal quality. As yet another example, Ec/Io (Energy per Chip/Interference) may be used in CDMA (Code Division Multiple Access) networks to assess the quality of a signal by comparing the signal energy per chip to the average interference and noise. As yet another example, RSCP (Received Signal Code Power) may be used in UMTS (Universal Mobile Telecommunications System) networks, as RSCP measures the received power of a specific code or signal within the network. As such, the use of RSSI should be taken as example only and not to otherwise limit the scope of the present disclosure.

In some implementations, connection process 110 may determine 304 that the signal strength value of the first type of wireless network connected between the client electronic device and the infotainment system exceeds a threshold value. For instance, and continuing with the above example, assume that the RSSI threshold value is −30 dB, and the RSSI value of the first type of wireless network connected between the client electronic device and the infotainment system is −25 dB. In the example, connection process 110 would determine that the signal strength value of the first type of wireless network (−25 dB) connected between the client electronic device and the infotainment system exceeds the threshold value of −30 dB. In the example, this threshold value may indicate whether the Bluetooth connection from client electronic devices 142 to the infotainment system is “strong,” and in this case, the indication is that the Bluetooth connection from client electronic devices 142 to the infotainment system is not strong (i.e., weak).

In some implementations, connection process 110 may establish 306 a connection between the client electronic device and the infotainment system via a second type of wireless network based upon, at least in part, the signal strength value the first type of wireless network connected between the client electronic device and the infotainment system exceeding the threshold value. For instance, and continuing with the above example where the indication is that the Bluetooth connection from client electronic devices 142 to the infotainment system is not strong (i.e., weak), connection process 110 may establish a connection between client electronic devices 142 and the infotainment system using a different type of wireless network other than Bluetooth.

In some implementations, the second type of wireless network may have a weaker signal strength than the first type of wireless network, and in some implementations, the second type of wireless network may operate on a different frequency band than the first type of wireless network. For instance, the second type of wireless network may be a Wi-Fi connection, which may have a weaker signal strength than Bluetooth and may operate in different frequency bands than Bluetooth (e.g., 2.4 GHz and/or 5.0 GHz).

In some implementations, connection process 110 may attempt 308 to establish a second connection between a second client electronic device and the infotainment system via the first type of wireless network while the infotainment system is establishing the connection with the client electronic device via the second type of wireless network. For instance, and continuing with the above example, while connection process 110 is connecting (or attempting to connect) client electronic devices 142 to the infotainment system via the Wi-Fi network, connection process 110 may attempt to establish a connection between a different client electronic device (e.g., client electronic devices 144) and the infotainment system using Bluetooth.

In some implementations, connection process 110 may display 310 a message indicating whether the client electronic device successfully connected to the infotainment system. For instance, there may be some circumstances where it should be communicated to users 148 that connection to the infotainment system using either client electronic devices 142 and/or client electronic devices 144 was not successful. For example, if the Bluetooth connection failed a predetermined number of times, or if the RSSI indicates that the Bluetooth connection between client electronic devices 142 and the infotainment system is strong (indicating that there should be a Wi-Fi connection) but yet there is no Wi-Fi connection, then connection process 110 may use a display of the infotainment system to display a message to user 148 indicating a failure to connect message. In some implementations, displaying the message to user 148 indicating a failure to connect message may include sending a text message, email, etc. with haptic outputs, textual and/or text-to-speech audio output.

Referring also at least to the example implementation of FIG. 4, an alternate view of connection process 110 is shown. In step 1, once the vehicle completes the remote start, the infotainment system (also referred to by example only as a head-unit (HU)) may, at step 2, start the Bluetooth connection processing. In step 3, connection process 110 may determine if there is a Bluetooth connection. If there is no device detected using Bluetooth, connection process 110 may return to step 2. In step 4, if the device is detected but failed to connect, a connection failure message may appear on the HU (or elsewhere as discussed above). In the example, this message may require user action to retry/cancel (step 5). In step 6, connection attempts may be cancelled, and connection process 110 may proceed to step 2 for connecting the next device to Bluetooth.

If a device is detected and connected, step 9 determines whether the device is able to connect to the HU (e.g., able to connect to one of the applications of the HU, such as Apple CarPlay (CP) and Android Auto (AA)). If the device does not need to connect to AA/CP, then the connection does not require a Wi-Fi connection, thus the process will end at step 6. Again, connection process 110 will proceed to step 2 to try and establish a Bluetooth connection for the next device. If the device is used for the AA/CP connection, at step 10, Wi-Fi connection processing begins (while looping through Wi-Fi connection processing for AA/CP device, proceeds to step 2 for Bluetooth connection processing for the next device.

At step 11, connection process 110 determines whether there is a Wi-Fi connection. If the device is not connected, at step 12, it is determined whether the Bluetooth RSSI is strong. If the RSSI value is strong, Wi-Fi should have connected. Therefore, at step 7, the HU may display a wireless connection failure message. This message may require user action to Retry/Cancel (at step 8). If the RSSI value is not strong, indicating the device is out of range for Bluetooth connection detection, connection process 110 may go to step 10 for Wi-Fi connection processing. If the device is detected, connection process 110 may got to step 6 to end, and proceed to step 2 for the Bluetooth connection processing for the next device.

The terminology used herein is for the purpose of describing particular implementations only and is not intended to be limiting of the disclosure. As used herein, the singular forms “a”, “an” and “the” are intended to include the plural forms as well, including any steps performed by a/the computer/processor, unless the context clearly indicates otherwise. As used herein, the phrase “at least one of A, B, and C” should be construed to mean a logical (A OR B OR C), using a non-exclusive logical OR, and should not be construed to mean “at least one of A, at least one of B, and at least one of C.” As another example, the language “at least one of A and B” (and the like) as well as “at least one of A or B” (and the like) should be interpreted as covering only A, only B, or both A and B, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof. Example sizes/models/values/ranges can have been given, although examples are not limited to the same.

The terms (and those similar to) “coupled,” “attached,” “connected,” “adjoining,” “transmitting,” “receiving,” “connected,” “engaged,” “adjacent,” “next to,” “on top of,” “above,” “below,” “abutting,” and “disposed,” used herein is to refer to any type of relationship, direct or indirect, between the components in question, and is to apply to electrical, mechanical, fluid, optical, electromagnetic, electromechanical, or other connections. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action is to occur, either in a direct or indirect manner. The term “set” does not necessarily exclude the empty set—in other words, in some circumstances a “set” may have zero elements. The term “non-empty set” may be used to indicate exclusion of the empty set—that is, a non-empty set must have one or more elements, but this term need not be specifically used. The term “subset” does not necessarily require a proper subset. In other words, a “subset” of a first set may be coextensive with (equal to) the first set. Further, the term “subset” does not necessarily exclude the empty set—in some circumstances a “subset” may have zero elements.

The corresponding structures, materials, acts, and equivalents (e.g., of all means or step plus function elements) that may be in the claims below are intended to include any structure, material, or act for performing the function in combination with other claimed elements as specifically claimed. While the disclosure describes structures corresponding to claimed elements, those elements do not necessarily invoke a means plus function interpretation unless they explicitly use the signifier “means for.” Unless otherwise indicated, recitations of ranges of values are merely intended to serve as a shorthand way of referring individually to each separate value falling within the range, and each separate value is hereby incorporated into the specification as if it were individually recited. While the drawings divide elements of the disclosure into different functional blocks or action blocks, these divisions are for illustration only. According to the principles of the present disclosure, functionality can be combined in other ways such that some or all functionality from multiple separately-depicted blocks can be implemented in a single functional block; similarly, functionality depicted in a single block may be separated into multiple blocks. Unless explicitly stated as mutually exclusive, features depicted in different drawings can be combined consistent with the principles of the present disclosure. Moreover, although this disclosure describes and depicts respective implementations herein as including particular components, elements, feature, functions, operations, or steps (and arrangements thereof), any of these implementations may include any combination, arrangement, or permutation of any of the components, elements, features, functions, operations, or steps described or depicted anywhere herein that a person having ordinary skill in the art would comprehend after reading the present disclosure. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

The description of the present disclosure has been presented for purposes of illustration and description but is not intended to be exhaustive or limited to the disclosure in the form disclosed. After reading the present disclosure, many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated. The features of any dependent claim may be combined with the features of any of the independent claims or other dependent claims.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A computer-implemented method comprising:
detecting, by an infotainment system of a vehicle, that a client electronic device has a connection to the infotainment system via a first type of wireless network;
detecting a signal strength value of the first type of wireless network connected between the client electronic device and the infotainment system;
determining that the signal strength value of the first type of wireless network connected between the client electronic device and the infotainment system exceeds a threshold value; and
establishing a connection between the client electronic device and the infotainment system via a second type of wireless network based upon, at least in part, the signal strength value the first type of wireless network connected between the client electronic device and the infotainment system exceeding the threshold value.

2. The computer-implemented method of claim 1, wherein detecting that the client electronic device is connected to the infotainment system via the first type of wireless network occurs after a remote starting of the vehicle.

3. The computer-implemented method of claim 1, wherein the second type of wireless network has a weaker signal strength than the first type of wireless network.

4. The computer-implemented method of claim 1, wherein the second type of wireless network operates on a different frequency band than the first type of wireless network.

5. The computer-implemented method of claim 1, wherein the signal strength value of the first type of wireless network is a Received Signal Strength Indicator (RSSI).

6. The computer-implemented method of claim 1 further comprising displaying a message indicating whether the client electronic device successfully connected to the infotainment system.

7. The computer-implemented method of claim 1 further comprising attempting to establish a second connection between a second client electronic device and the infotainment system via the first type of wireless network while the infotainment system is establishing the connection with the client electronic device via the second type of wireless network.

8. A computer program product residing on a computer readable storage medium having a plurality of instructions stored thereon which, when executed across one or more processors, causes at least a portion of the one or more processors to perform operations comprising:
detecting, by an infotainment system of a vehicle, that a client electronic device has a connection to the infotainment system via a first type of wireless network;
detecting a signal strength value of the first type of wireless network connected between the client electronic device and the infotainment system;
determining that the signal strength value of the first type of wireless network connected between the client electronic device and the infotainment system exceeds a threshold value; and
establishing a connection between the client electronic device and the infotainment system via a second type of wireless network based upon, at least in part, the signal strength value the first type of wireless network connected between the client electronic device and the infotainment system exceeding the threshold value.

9. The computer program product of claim 8, wherein detecting that the client electronic device is connected to the infotainment system via the first type of wireless network occurs after a remote starting of the vehicle.

10. The computer program product of claim 8, wherein the second type of wireless network has a weaker signal strength than the first type of wireless network.

11. The computer program product of claim 8, wherein the second type of wireless network operates on a different frequency band than the first type of wireless network.

12. The computer program product of claim 8, wherein the signal strength value of the first type of wireless network is a Received Signal Strength Indicator (RSSI).

13. The computer program product of claim 8, wherein the operations further comprise displaying a message indicating whether the client electronic device successfully connected to the infotainment system.

14. The computer program product of claim 8, wherein the operations further comprise attempting to establish a second connection between a second client electronic device and the infotainment system via the first type of wireless network while the infotainment system is establishing the connection with the client electronic device via the second type of wireless network.

15. A computing system including one or more processors and one or more memories configured to perform operations comprising:
detecting, by an infotainment system of a vehicle, that a client electronic device has a connection to the infotainment system via a first type of wireless network;
detecting a signal strength value of the first type of wireless network connected between the client electronic device and the infotainment system;
determining that the signal strength value of the first type of wireless network connected between the client electronic device and the infotainment system exceeds a threshold value; and
establishing a connection between the client electronic device and the infotainment system via a second type of wireless network based upon, at least in part, the signal strength value the first type of wireless network connected between the client electronic device and the infotainment system exceeding the threshold value.

16. The computing system of claim 15, wherein detecting that the client electronic device is connected to the infotainment system via the first type of wireless network occurs after a remote starting of the vehicle.

17. The computing system of claim 15, wherein the second type of wireless network has a weaker signal strength than the first type of wireless network.

18. The computing system of claim 15, wherein the second type of wireless network operates on a different frequency band than the first type of wireless network.

19. The computing system of claim 15, wherein the signal strength value of the first type of wireless network is a Received Signal Strength Indicator (RSSI).

20. The computing system of claim 15, wherein the operations further comprise attempting to establish a second connection between a second client electronic device and the infotainment system via the first type of wireless network while the infotainment system is establishing the connection with the client electronic device via the second type of wireless network.
